(19) United States
(12) Patent Application Publication
(10) Pub. No.: US 2025/0129763 A1
(43) Pub. Date: Apr. 24, 2025

(54) WAVE POWER GENERATION SYSTEM

(71) Applicant: Hydrosine Dynamics, Inc., Overland Park, KS (US)

(72) Inventor: William HALL, Overland Park, KS (US)

(21) Appl. No.: 18/681,413

(22) PCT Filed: Aug. 4, 2022
(86) PCT No.: PCT/US2022/039372

§ 371 Date: Feb. 5, 2024

Related U.S. Application Data
(60) Provisional application No. 63/229,629, filed on Aug. 5, 2021.

(51) Int. Cl. F03B 13/22

(52) U.S. Cl. CPC F03B 13/22; F05B 2210/11; F05B 2250/72

(57) ABSTRACT

Systems and methods for generating electricity from the waves of a body of water are provided. Generally, the system comprises apparatus that includes at least two tanks and a turbine that is situated intermediate conduit structure that interconnects the two tanks. The cresting of a wave that impinges upon the apparatus fills one of the tanks. This water is directed through a turbine and generator assembly while flowing between the tanks. The other of the tanks is configured to empty during the troughing of the wave.

### RELATED APPLICATION

This application claims the benefit of U.S. Provisional Patent Application No. 63/229,629, filed Aug. 5, 2021, which is incorporated by reference herein in its entirety.

### BACKGROUND OF THE INVENTION

### Field of the Invention

The present invention is directed toward a system for generating electricity from the waves of a body of water. The system comprises apparatus including at least two tanks and a turbine that is situated intermediate conduit structure that interconnects the two tanks. Water flowing between the tanks is directed through the turbine, which is connected to a generator.

### Description of the Prior Art

As over 70% of the earth's surface is covered by oceans, ocean waves present a nearly limitless supply of energy. However, harnessing this energy and transforming into a useable form that is economically competitive with conventional energy sources, such as fossil fuels, has proven challenging.

A number of devices have been proposed in order to capture the energy contained in ocean waves and convert it into electrical power. One such class of devices are wave profile devices. Wave profile devices float on or near to the ocean surface and move in response to the shape of the incident wave in a substantially vertical motion. The pitching and heaving of the waves cause a relative motion between an absorber and a reaction point to produce an oscillating system that powers a hydraulic pump, which in turn rotates a generator. A major shortcoming of these types of devices is the ability to scale them sufficiently to produce energy in sufficient quantity to be useful to a city or municipality. Typically, these types of devices are used only to power small devices such as navigational buoys.

Another class of devices used to harness wave energy is the oscillating column wave energy device. These devices are normally positioned onto or near rocks or cliffs which are next to a deep sea bottom. They comprise a partially submerged hollow chamber that is fixed directly at the shoreline. As a wave enters the device, an air column is compressed. As the wave recedes, the air column is decompressed. This oscillating column of air is directed through a wind turbine which produces electricity. Scalability is also a concern with these types of devices. Moreover, finding suitable locations to install such devices can also prove challenging, not to mention the potential environmental and aesthetic impacts these devices might have in being situated on a shoreline.

A third class of devices is capture wave energy devices. These devices comprise structure configured to capture water within a floating reservoir, typically by providing a ramp upon which the wave can ride up and spill over into the reservoir. Once captured, the water is then directed out of the reservoir through a turbine. However, these types of devices are designed to operate in connection with waves having a minimum amplitude so that the water does in fact spill over into the reservoir. If such minimum amplitude is not met, the device will not generate power. Thus, these types of devices can be as unpredictable in providing power as conventional wind turbines. Moreover, there is a lack of workable low-head turbine technology to generate power on a scale comparable to conventional municipal or regional power generation facilities.

Accordingly, a need exists in the art for a device that can harness wave energy that is not encumbered by the difficulties with existing technologies as noted above. In particular, there is a need for a device that can be positioned away from land, that is scalable to provide power on par with conventional land-based power plants for providing power to a municipality, and that can provide power even in sea conditions where wave amplitude can vary considerably.

### SUMMARY OF THE INVENTION

The present invention overcomes the problems noted above and provides a system for producing electricity from waves that is scalable, aesthetically unobtrusive, and can operate in a variety of wave conditions.

According to one embodiment of the present invention there is provided apparatus for generating electricity. The apparatus comprises a buoyant body having first and second tanks. The first tank is located at a higher elevation within the buoyant body than the second tank. A plurality of water inlets is formed in the buoyant body and interconnect the body's exterior with the interior of the first tank and permit flow of water into the first tank from the exterior of the buoyant body. A plurality of water outlets is formed in the buoyant body and interconnect the body's exterior with the interior of the second tank and permit flow from the interior of the second tank to the exterior of the buoyant body. Conduit structure interconnects the first and second tanks and is configured to direct a flow of water from the first tank and into the second tank under a head pressure generated by the water within the first tank. An annular turbine is installed intermediate the conduit structure and comprises a plurality of blades across which water flowing within the conduit structure is directed thereby rotating the turbine. A generator is operably connected with the turbine and configured to generate electrical power upon rotation of the turbine.

According to another embodiment of the present invention there is provided apparatus for generating electricity comprising a buoyant body having first and second tanks, a plurality of water inlets and water outlets formed in the buoyant body, conduit structure interconnecting the first and second tanks, a turbine, and a generator. The first tank is preferably located at a higher elevation within the buoyant body than the second tank. The plurality of water inlets formed in the buoyant body interconnect the body's exterior with the interior of the first tank and permit flow of water into the first tank from the exterior of the buoyant body. The plurality of water outlets formed in the buoyant body interconnect the body's exterior with the interior of the second tank and permit flow from the interior of the second tank to the exterior of the buoyant body. The conduit structure interconnects the first and second tanks and is configured to direct a flow of water from the first tank and into the second tank under a head pressure generated by the water within the first tank. The turbine is installed intermediate the conduit structure and comprises a plurality of blades across which water flowing within the conduit structure is directed thereby rotating the turbine. The generator is operably connected with the turbine and configured to generate electrical power upon rotation of the turbine. The conduit structure preferably is configured to direct water flowing therethrough upstream of the turbine from the first tank to a first conduit segment that is located beneath the elevation of the turbine, and then to a second conduit segment that is located above the elevation of the turbine.

According to a further embodiment of the present invention there is provided a method of generating electricity from waves within a body of water. Water is flowed into a first tank of a buoyant body floating in the body of water during the crest of a wave. The water enters the first tank through a plurality of inlets formed in the buoyant body. The water contained within the first tank generates a head pressure. The head pressure generated in the first tank causes water to flow from the first tank through a conduit structure and into a second tank. As the flow of water traverses the conduit structure, the water is passed across a plurality of blades of an annular turbine located intermediate the conduit structure and causes the annular turbine to rotate. The annular turbine is connected to a generator that generates electricity upon rotation of the annular turbine. Water is then flowed out of the second tank through a plurality of outlets formed in the buoyant body during the trough of the wave.

According to still a further embodiment of the present invention there is provided a method of generating electricity from waves within a body of water. Water is flowed into a first tank of a buoyant body floating in the body of water during the crest of a wave. The water enters the first tank through a plurality of inlets formed in the buoyant body. The water contained within the first tank generates a head pressure. The head pressure generated in the first tank causes water to flow from the first tank through a conduit structure and into a second tank. As the flow of water traverses the conduit structure, the water passes across a plurality of blades of a turbine located intermediate the conduit structure and causes the turbine to rotate. The turbine is operably connected to a generator, which generates electricity upon rotation of the turbine. As the water flows from the first tank toward the turbine, the flow of water enters a first conduit section that is located beneath the elevation of the turbine and then is directed upward toward a second conduit section that is located above the elevation of the turbine. Water is then flowed out of the second tank through a plurality of outlets formed in the buoyant body during the trough of the wave.

### BRIEF DESCRIPTION OF THE DRAWINGS

FIG. 1 is a perspective view of power generating apparatus according to one embodiment of the present invention positioned in a body of water;

FIG. 2 is an upper perspective view of the apparatus of FIG. 1;

FIG. 3 is a lower perspective view of the apparatus of FIG. 1;

FIG. 4 is an exploded view of the apparatus of FIG. 1;

FIG. 5 is a side elevation view of the apparatus of FIG. 1 encountering a wave within the body of water;

FIG. 6 is a sectioned view of the apparatus of FIG. 1 and depicting the flow path of water through the apparatus;

FIG. 7 is a chart depicting available fluid power versus tank diameter; and

FIG. 8 is a chart depicting the relationship between body length and power produced at an assumed turbine operating efficiency of 40%.

While the drawings do not necessarily provide exact dimensions or tolerances for the illustrated components or structures, the drawings are to scale with respect to the relationships between the components of the structures illustrated in the drawings.

### DETAILED DESCRIPTION OF THE PREFERRED EMBODIMENT

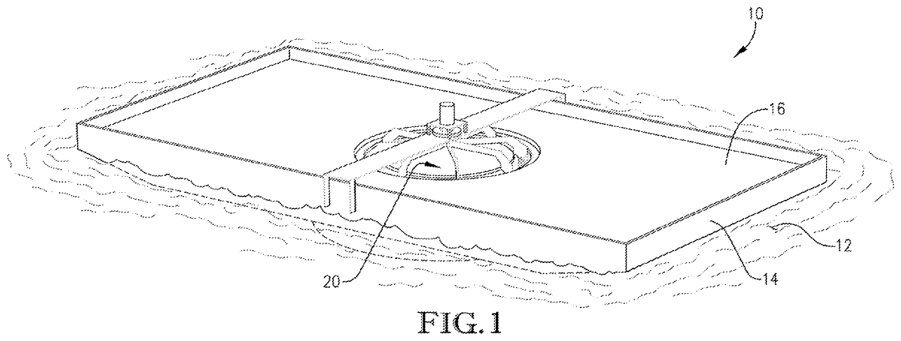

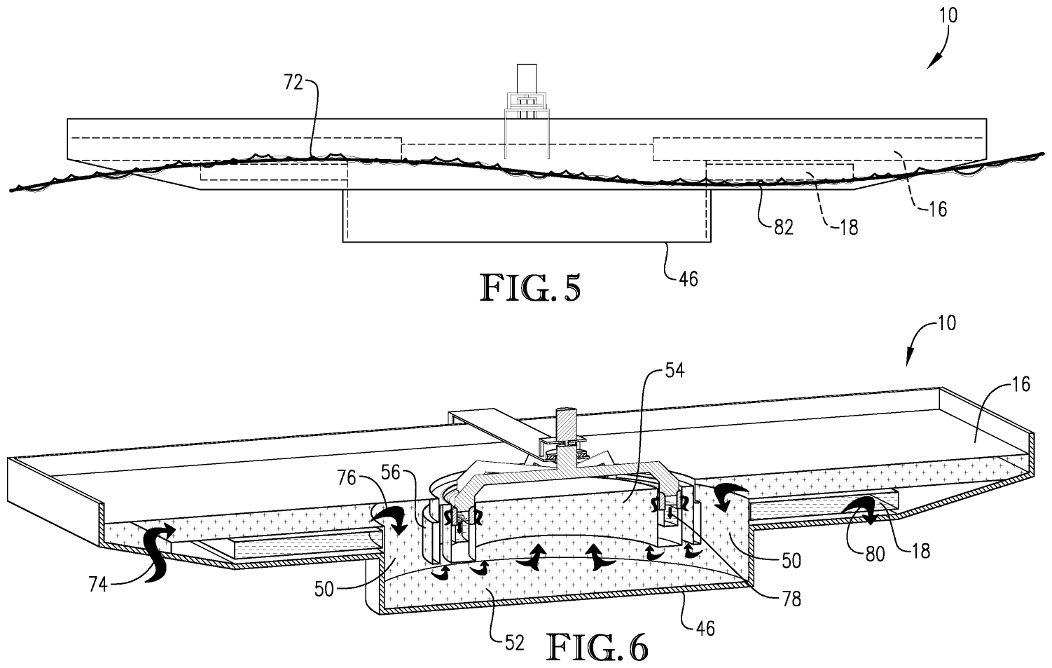

Turning now to FIG. 1, power generation apparatus 10 is depicted floating in a body of water 12. Apparatus 10 comprises a buoyant body 14, which may resemble the hull of a barge or other marine vessel. Body 14 is configured to contain at least first and second tanks 16, 18 (see, FIG. 5), and a turbine assembly 20. Body 14 can be formed from any material that is adaptable for the purposes described herein. For example, body 14 can comprise concrete (e.g., reinforced concrete), metal plate, fiberglass, or the like. In one or more embodiments, it is preferable for the apparatus 10 to remain stationary, or at the very least within a confined area. Thus, apparatus 10 may be tethered to the sea floor or be equipped with location stabilizing equipment, such as directional propellers and other control surfaces (not shown).

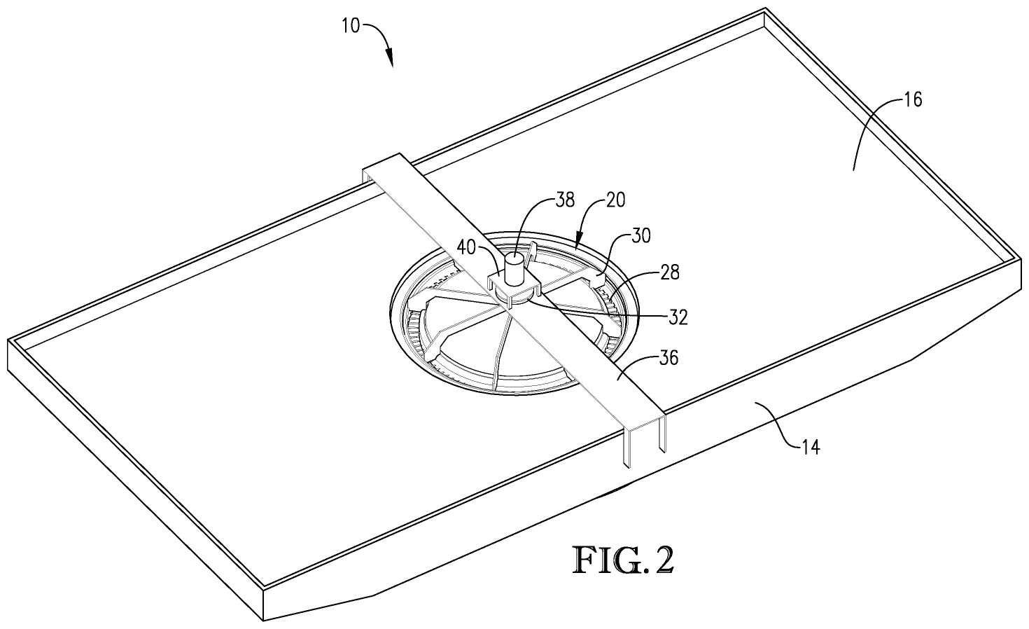

As can be seen in FIG. 2, turbine assembly 20 comprises a turbine 22 that is installed within openings 24, 26 formed within tanks 16, 18, respectively. Turbine 22 comprises a plurality of blades 28 and is configured to rotate when water is passed over the turbine blades 28. Turbine 20 is supported by a plurality of support arms 30 that are secured to a hub 32. Hub 32 is secured to a drive shaft or rotor 34, all of which are supported by a mounting support 36 secured to buoyant body 14. Drive shaft 34 is operably connected to an electrical generator 38 that is supported by a platform 40 attached to mounting support 36. It is noted that apparatus 10 is shown as having only a single turbine assembly; however, it is within the scope of the present invention for apparatus 10 to be provided with a plurality of turbine assemblies as necessary for a given application.

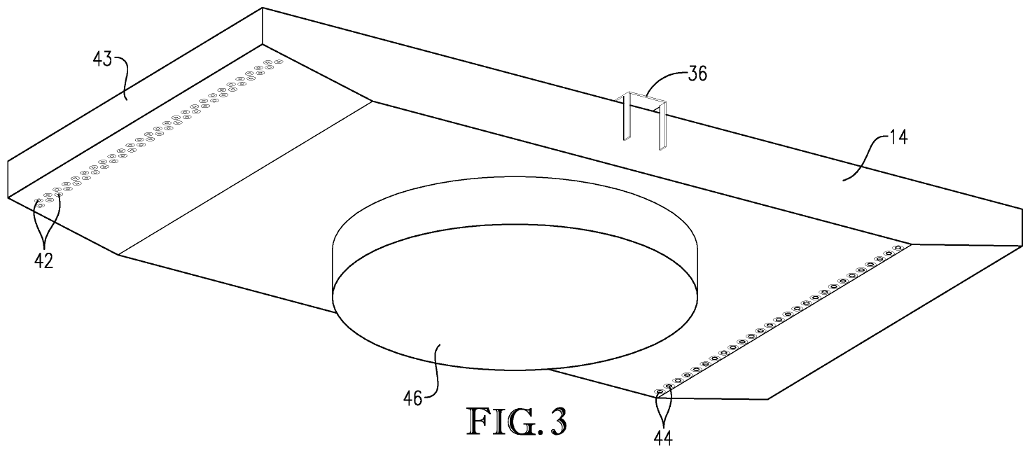

As illustrated in FIG. 3, body 14 comprises a plurality of inlets 42 and outlets 44 configured for ingress and egress of water into and from body 14, and especially tanks 16, 18. In one or more embodiments, inlets 42 comprise one-way flow or check valves that operate to permit flow of water into first tank 16 and prevent or at least retard flow of water in the opposite direction. Any type of suitable one-way flow valve may be used, including, for example, a ball-check valve, a Tesla valve, a duckbill valve, a flapper valve, a diaphragm valve, a lift-check valve, and a reed valve. Inlets 42 interconnect the exterior of body 14 with the interior of tank 16. Inlets 42 may be placed not only on the bottom surface of body 14, but also on the body's sidewall 43. Moreover, inlets 42 are not the only means for water to enter first tank 16. As depicted tank 16 comprises a top that is open to the atmosphere. Thus, tank 16 is configured to admit water from above, such as from spilling over sidewall 43 or as rain.

Outlets 44 interconnect the exterior of body 14 with tank 18. In one or more embodiments, outlets 44 also comprise one-way flow valves, much like inlets 42, to permit flow of water out of tank 18, but not into tank 18 from the exterior of body 14.

In one or more embodiments, body 14 comprises a long, narrow profile, although other configurations are within the scope of the present invention. However, a long and narrow profile, determined by the length: width aspect ratio, helps to ensure an adequate flow of water across turbine 22. In preferred embodiments, the length: width aspect ratio of body 14 is between 20:1 to 2:1, between 10:1 to 2.5:1, or between 5:1 to 3:1.

Body 14 may also comprise a recessed portion 46 formed on the body's underside to accommodate turbine assembly 20 and all conduit structure for delivering water from tank 16 to tank 18, which is described in greater detail below.

In one or more embodiments, first tank 16 is located immediately above and in covering relationship to at least a portion of the second tank. In fact, tanks 16, 18 may be separated by a common wall structure, if desired. In certain embodiments, the volume of the lower tank 18 is less than the volume of the first tank 16, although this need not always be the case.

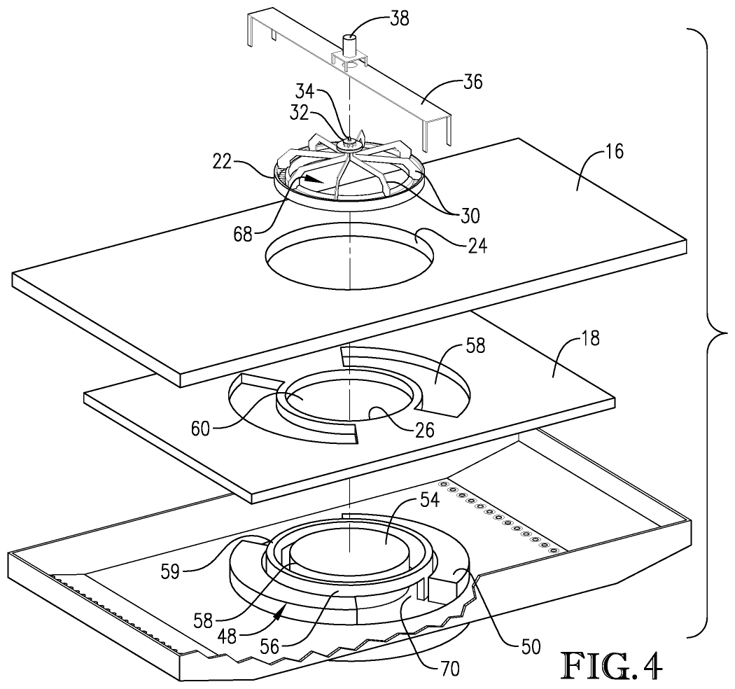

As can be seen in FIG. 4, conduit structure 48 is provided as means for interconnecting the first and second tanks 16, 18. Conduit structure 48 need not be configured as conventional piping, but as duct work for directing a flow of water between the two tanks. Conduit structure 48 comprises a collector segment 50 that is configured to receive water was tank 16 and direct the water in a downward direction toward a distribution segment 52, which is located below the elevation of the turbine 22, and in particular the turbine blades 28. The distribution segment 52 is then connected to a central water passage 54 and an annular passage 56. Passages 54, 56 are configured to flow water in an upward direction to a location that is above the elevation of the turbine blades 28, but below the height of the water within tank 16. The upper margins of passages 54, 56 may be provided with inner and outer weir structure 58, 59 over which water must flow to enter the turbine 22. Lower tank 18 comprises cut out segments 60, 62 formed therein to accommodate conduit structure 48. It will be appreciated that the specific geometry of conduit structure 48 can be modified as necessary to meet a specific application and provide the necessary water flow rate.

As can be seen, turbine 20 is configured as an annular turbine that comprises an inner ring member 64 and an outer ring member 66 with the turbine blades 28 secured therebetween. Other types of turbines may be used in one or more embodiments of the present invention; however, annular turbine 20 is preferred in certain applications. Arms 30 also interconnect inner and outer rings 64 with hub 32. It is noted that other bearing structure (not shown) may be provided to facilitate rotation of turbine 22 within opening 24 formed in upper tank 16.

Conduit structure 48 is configured such that water flowing therewithin flows in board and outboard of the annular turbine 22. Specifically, central passage 54 directs water upward through an inner turbine opening 68 defined at least in part by inner ring 64. Water flowing through annular passage 56 flows outboard of the margin defined by outer ring member 66. Conduit structure 48 also comprises an outlet segment 70 that is configured to collect water that has passed through turbine 22 and direct that water into lower tank 18.

Turning to FIGS. 5 and 6, operation of apparatus 10 is illustrated. In particular, FIG. 5 depicts apparatus 10 floating in a body of water and encountering a wave. The wave crest 72 impacts a portion buoyant body 14 such that the crest level is above the level of at least some of the inlets 42. Water is then directed through inlets 42 and into upper tank 16 as depicted by arrow 74 in FIG. 6. The height of the water contained within tank 16 develops a head pressure that provides the necessary force for transference of the water from tank 16 into lower tank 18.

In one or more embodiments, tank 16 is configured to direct a flow of water into conduit structure 48. This flow is represented by arrow 76. Preferably, there is no mechanical valve or controller to control the flow rate of the water into conduit structure 48; however, using some type of flow control system would be within the scope of the present invention. The water initially enters collector segment 50 where it is directly downwardly into recessed portion 46. The water within collector segment 50 flows below the elevation of turbine 22 and into distribution segment 52. In distribution segment 52, the flow of water is divided and directly upwardly towards turbine 22. One portion of the water is directed into central passage 54, and another portion of the water is directed into annular passage 56. Once the water in passages 54 and 56 reaches a level above the turbine, the water flows over weir structures 58, 59 and onto the turbine blades 28 causing the turbine to rotate and provide mechanical energy to power. By flowing water onto the turbine blades 28 from both the inboard and outboard sides, it is ensured that the water is distributed evenly across the entirety of the blade surfaces. If water were flowed from only one of the inboard and outboard sides of the blades 28, it cannot be guaranteed that the entire surface of the turbine blades would be contacted with water and that the turbine 22 would rotate adequately to generate the desired amount of electricity. This configuration also permits a large diameter turbine to be employed that is capable of powering a high-output generator that can output hundreds of thousands, and even millions, of watts of electrical power.

It is important to note that turbine 22 does not require a large head pressure acting directly on the turbine blades. Therefore, in one or more embodiments, the actual head acting upon the turbine blades is less than 1 m, less than 0.75 m, less than 0.5 m, or less than 0.25 m of water. These values also represent the height of weir structures 58, 59 over the turbine blades 28. Rather, it is the flow rate of water through conduit structure 48 and onto turbine blades 28 that provides the motive force for rotation of the turbine.

Thus, the flow of water within apparatus 10 more closely analogized with a river than a waterfall. A minimum head pressure is required in order for the water to flow between tanks 16, 18, however, the turbine 22 is a low head turbine, the rotation of which is more dependent upon water flow rate than head pressure. In one or more embodiments, the water flowing through conduit structure 48 has a linear velocity of at least 1 m/s, at least 2 m/s, or at least 4 m/s.

Once the water has passed through the turbine blades 28, the water is directed through an outlet segment 70 of conduit structure 48 as represented by arrow 78. Outlet segment 70 directs the water into the lower tank 18 where it can be distributed to the plurality of outlets 44 where the water is discharged from the buoyant body 14 as represented by arrow 80 when encountering the trough 82 of a wave.

Thus, apparatus 10 takes advantage of the height differential between the crest and trough of a wave to fill a tank or reservoir with water during the cresting of a wave, flow that water across a turbine for generating power, and then discharge the water from the apparatus during the troughing of the wave. In certain embodiments, apparatus 10 can be configured to reliably produce power when the wave amplitude is as little as 1.0 m, 0.75 m, or 0.5 m, which permits apparatus 10 to be used in nearly any portion of the earth's ocean surface.

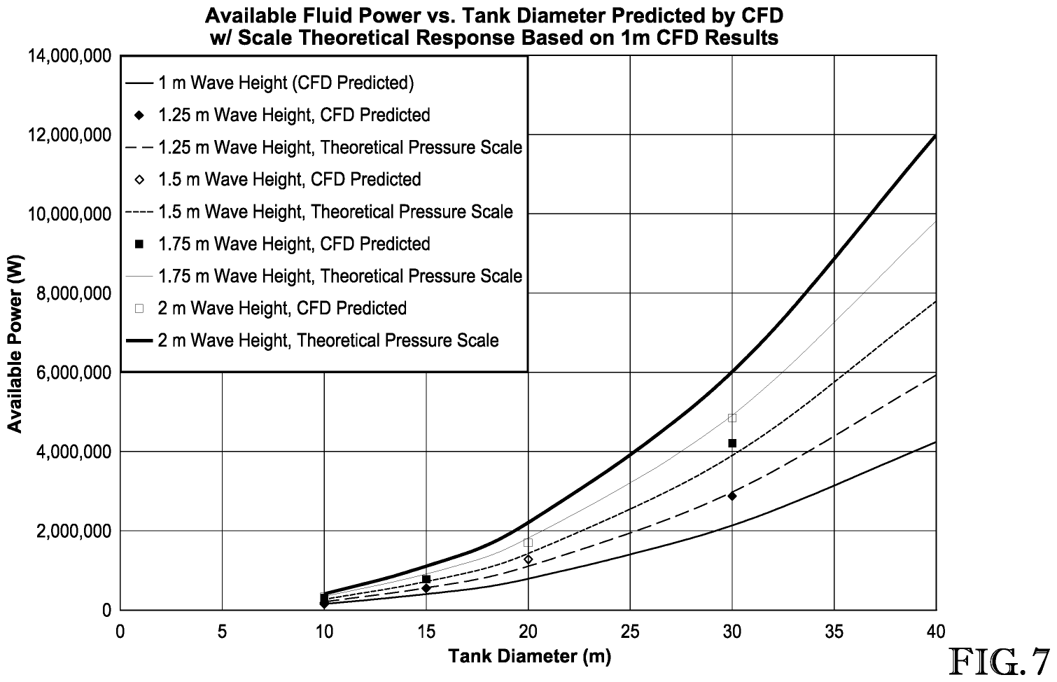

Computer fluid dynamics (CFD) modeling of one embodiment of the present invention was performed assuming varying wave height, tank and turbine sizes, and spillover height onto the turbine blades. FIG. 7 shows a chart showing the available fluid power from waves having heights (from crest to trough) ranging from 1 m to 2 m as predicted by CFD modeling. The theoretical scale is also shown for various wave heights as a comparison. A spillover height onto the turbine blades of 0.5 m is assumed. As can be seen, at tank diameter of 10 m (tank diameter being equivalent to the diameter of the turbine and conduit assemblies surrounding and flowing within the turbine) variations in wave height do not meaningfully impact the power available to be harnessed. However, as tank diameter increases (along with water flow rate), small differences in wave height significantly affect the amount of power available for the system. Variations between the CFD model and theoretical pressure scale indicate that expected bottlenecking flow restrictions are present within the system at higher pressures. FIG. 7 gives an indication of the amount of power embodiments of the present invention are capable of generating. Even assuming turbine efficiencies of 50-70%, turbine diameters of 15 m or more, with very low wave height, would still be capable of megawatt-level power generation.

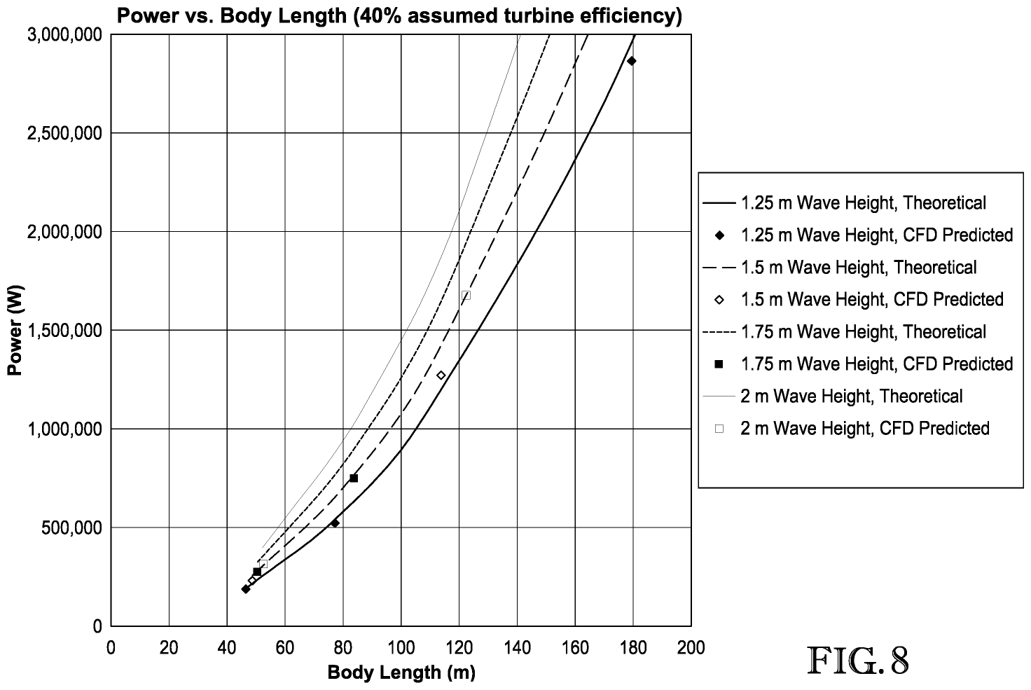

FIG. 8 is a chart showing how buoyant body 14 length relates to power produced for different assumed wave heights. A 0.5 m spillover height onto the turbine blades is assumed as is a turbine efficiency of 40%. As can be seen, the longer the length of body 14, the greater the power available to be harnessed. This indicates availability of a greater flow rate of water through the turbine without necessarily requiring an increase in wave height.

1. Apparatus for generating electricity comprising:
a buoyant body comprising first and second tanks, the first tank being located at a higher elevation within the buoyant body than the second tank;
a plurality of water inlets formed in the buoyant body and interconnecting the body's exterior with the interior of the first tank and permitting flow of water into the first tank from the exterior of the buoyant body;
a plurality of water outlets formed in the buoyant body and interconnecting the body's exterior with the interior of the second tank and permitting flow from the interior of the second tank to the exterior of the buoyant body;
conduit structure interconnecting the first and second tanks and configured to direct a flow of water from the first tank and into the second tank under a head pressure generated by the water within the first tank;
an annular turbine installed intermediate the conduit structure and comprising a plurality of blades across which water flowing within the conduit structure is directed thereby rotating the turbine; and
a generator operably connected with the turbine and configured to generate electrical power upon rotation of the turbine.

2. The apparatus of claim 1, wherein the conduit structure is configured such that water flowing therewithin flows inboard and outboard of the annular turbine.

3. The apparatus of claim 2, wherein the conduit structure comprises an inner weir and an outer weir over which water flowing inboard and outboard of the annular turbine, respectively, must pass over prior to entering the annular turbine.

4. The apparatus of claim 1, wherein the annular turbine comprises a plurality of arms that connect the turbine with a drive shaft.

5. The apparatus of claim 5, wherein the drive shaft is operably connected to the generator.

6. The apparatus of claim 1, wherein at least a portion of the first tank is located immediately above and in covering relationship to at least a portion of the second tank.

7. The apparatus of claim 1, wherein the volume of the second tank is less than the volume of the first tank.

8. The apparatus of claim 1, wherein the apparatus includes a generator support mounted to the buoyant body upon which the generator is mounted, the generator support being located above the turbine and the first tank.

9. The apparatus of claim 1, wherein the first tank is open to the atmosphere and configured to admit water from above the buoyant body.

10. Apparatus for generating electricity comprising:
a buoyant body comprising first and second tanks, the first tank being located at a higher elevation within the buoyant body than the second tank;
a plurality of water inlets formed in the buoyant body and interconnecting the body's exterior with the interior of the first tank and permitting flow of water into the first tank from the exterior of the buoyant body;
a plurality of water outlets formed in the buoyant body and interconnecting the body's exterior with the interior of the second tank and permitting flow from the interior of the second tank to the exterior of the buoyant body;
conduit structure interconnecting the first and second tanks and configured to direct a flow of water from the first tank and into the second tank under a head pressure generated by the water within the first tank;
a turbine installed intermediate the conduit structure and comprising a plurality of blades across which water flowing within the conduit structure is directed thereby rotating the turbine; and
a generator operably connected with the turbine and configured to generate electrical power upon rotation of the turbine,
wherein the conduit structure is configured to direct water flowing therethrough upstream of the turbine from the first tank to a first conduit segment that is located beneath the elevation of the turbine, and then to a second conduit segment that is located above the elevation of the turbine.

11. The apparatus of claim 10, wherein the turbine is an annular turbine, and wherein the conduit structure is configured such that water flowing therewithin flows inboard and outboard of the annular turbine.

12. The apparatus of claim 11, wherein the conduit structure comprises an inner weir and an outer weir over which water flowing inboard and outboard of the annular turbine, respectively, must pass over prior to entering the annular turbine.

13. The apparatus of claim 11, wherein the annular turbine comprises a plurality of arms that connect the turbine with a drive shaft.

14. The apparatus of claim 13, wherein the drive shaft is operably connected to the generator.

15. The apparatus of claim 10, wherein at least a portion of the first tank is located immediately above and in covering relationship to at least a portion of the second tank.

16. The apparatus of claim 10, wherein the volume of the second tank is less than the volume of the first tank.

17. The apparatus of claim 10, wherein the apparatus includes a generator support mounted to the buoyant body upon which the generator is mounted, the generator support being located above the turbine and the first tank.

18. The apparatus of claim 10, wherein the first tank is open to the atmosphere and configured to admit water from above the buoyant body.

19. A method of generating electricity from waves within a body of water comprising:
flowing water into a first tank of a buoyant body floating in the body of water during the crest of a wave, the water entering the first tank through a plurality of inlets formed in the buoyant body, the water contained within the first tank generating a head pressure;
the head pressure generated in the first tank causing water to flow from the first tank through a conduit structure and into a second tank;
as the flow of water traverses the conduit structure, passing the water across a plurality of blades of an annular turbine located intermediate the conduit structure and causing the annular turbine to rotate, the annular turbine being operably connected to a generator;
generating electricity using the generator upon rotation of the annular turbine; and
flowing water out of the second tank through a plurality of outlets formed in the buoyant body during the trough of the wave.

20. The method of claim 19, wherein within the flow of water within the conduit structure upstream of the annular turbine flows upward within a central passage located inboard of the annular turbine and also flows upward within an annular passage located outboard of the annular turbine.

21. The method of claim 19, wherein the flow of water within the conduit structure upstream of the annular turbine flows downward through a first conduit section that is located beneath the elevation of the annular turbine and then flows upward through a second conduit section that is located above the elevation of the annular turbine.

22. A method of generating electricity from waves within a body of water comprising:
flowing water into a first tank of a buoyant body floating in the body of water during the crest of a wave, the water entering the first tank through a plurality of inlets formed in the buoyant body, the water contained within the first tank generating a head pressure;
the head pressure generated in the first tank causing water to flow from the first tank through a conduit structure and into a second tank;
as the flow of water traverses the conduit structure, passing the water across a plurality of blades of a turbine located intermediate the conduit structure and causing the turbine to rotate, the turbine being operably connected to a generator, wherein as the water flows from the first tank toward the turbine, the flow of water enters a first conduit section that is located beneath the elevation of the turbine and then is directed upward toward a second conduit section that is located above the elevation of the turbine;
generating electricity using the generator upon rotation of the turbine; and
flowing water out of the second tank through a plurality of outlets formed in the buoyant body during the trough of the wave.

23. The method of claim 22, wherein the turbine is an annular turbine, and wherein the flow of water within the conduit structure upstream of the annular turbine flows upward within a central passage located inboard of the annular turbine and also flows upward within an annular passage located outboard of the annular turbine.
